(19) United States
(12) Patent Application Publication
(10) Pub. No.: US 2026/0370321 A1
(43) Pub. Date: Nov. 19, 2026

(54) MEASUREMENT CONFIGURATIONS FOR REFERENCE SIGNALS FROM SATELLITES

(71) Applicant: Telefonaktiebolaget LM Ericsson (publ), Stockholm (SE)

(72) Inventors: Ming LI, Stockholm (SE); Zhixun TANG, Beijing (CN)

(73) Assignee: Telefonaktiebolaget LM Ericsson (publ), Stockholm (SE)

(21) Appl. No.: 19/137,562

(22) PCT Filed: Dec. 12, 2022
(86) PCT No.: PCT/EP2022/085343

§ 371 Date: Jun. 10, 2025

(51) Int. Cl. H04B 7/185; H04L 5/00; H04W 24/10; H04W 56/00

(52) U.S. Cl. CPC H04B 7/18552; H04L 5/0051; H04W 24/10; H04W 56/0015

(57) ABSTRACT

A wireless device (10) applies (1220) a first measurement configuration for at least one first measurement on one or more reference signals from one or more satellites (100) of a satellite radio access network of the wireless communication network. Further, the wireless device (10) applies (1240) at least one second measurement configuration for at least one second measurement on the one or more reference signals from the one or more satellites (100) of a satellite radio access network. The second measurement configuration is based on the at least one first measurement.

### TECHNICAL FIELD

The present disclosure relates to methods for controlling wireless communication and to corresponding devices, systems, and computer programs. More particularly in relation to measurement configurations for measuring reference signals from satellites.

### BACKGROUND

In wireless communication networks, e.g., as specified by 3GPP (3rd Generation Partnership Project), wireless connectivity is typically provided through a terrestrial network (TN), i.e., base stations located on or near the surface of the earth. For providing coverage in certain regions, wireless connectivity may also be provided via one or more satellites, i.e., through a non-terrestrial network. For example, usage of NTN deployments in the 5G (5th Generation) NR (New Radio) technology of 3GPP is addressed in 3GPP TR 38.811 V15.4.0 (2020 September) and in 3GPP TR 38.821 V16.1.0 (2021 May).

The usage of an NTN involves some challenges, including issues arising from the movement of the satellites and rather long propagation delays. The movement of the satellites typically results in coverage areas of the satellites, e.g., cells, which move with respect to the earth's surface, as compared to a TN, where the cells are typically stationary. For example, a LEO (Low Earth Orbit) satellite of an NTN may be visible to a UE (user equipment) on the ground only for a rather short time in the range of a few seconds or minutes. In a first deployment variant for such LEO satellite, the cell or beam coverage of the satellite is defined to be fixed with respect to a certain geographical location, using a concept referred to as quasi-earth-fixed beams or quasi-earth-fixed cells. In this case, steerable beams from satellites ensure that a certain beam covers the same geographical area even as the satellite moves in relation to the surface of the earth. In a second deployment, an LEO satellite has a fixed antenna pointing direction in relation to the earth's surface, e.g., perpendicular to the earth's surface. Accordingly, cell coverage or beam coverage of the satellite sweeps over the earth's surface as the satellite moves. In that case, a spotbeam serving the UE may switch every few seconds. In the case of a TN, the propagation delays between UE and ground-based access node are typically less than 1 ms. As compared to that, in the case of an NTN, the propagation delays between UE and satellite can be much longer, ranging from several milliseconds in the case of LEO satellites to hundreds of milliseconds in the case of GEO (geostationary) satellites, depending on the respective altitude of the satellite.

In an NTN, it can also occur that coverage areas of multiple different satellites overlap and that such overlaps vary over time. This is in contrast to the rather carefully designed coverage patterns of a TN. Management of mobility between cells of an NTN may thus involve more challenging tasks than in a TN. Long propagation delays also present challenges to measurement procedures which are for example needed in the mobility management. Specifically, the measurements typically need to cover a wide range of propagation delays from different satellites. This also applies to measurements for measurements of synchronization signals (SS), such as the PSS (Primary Synchronization Signal) and SSS (Secondary Synchronization Signal) of the NR technology, also denoted as NR-PSS and NR-SSS, respectively.

The PSS and SSS of the NR technology are transmitted on the NR PBCH (Physical Broadcast Channel), and the combination of SS and PBCH is also referred to as SSB (Synchronization Signal Block). Typically, multiple SSBs are transmitted in a burst set, as schematically illustrated in FIG. 1. Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms, where the unit used in the configuration is subframe, which has a duration of 1 ms. A UE does not need to perform measurements with the same periodicity as the SSB periodicity. Rather, the timing of the measurements by the UE can be defined by a SSB measurement time configuration (SMTC), configured by Radio Resource Control (RRC) signaling. The signaling of an SMTC window informs the UE of the timing and periodicity of SSBs that the UE can use for measurements. The SMTC window periodicity can be configured from the value set {5, 10, 20, 40, 80, 160} ms, thus matching the possible SSB periodicities. The SMTC window duration can be configured from the value set {1, 2, 3, 4, 5} ms, where the unit used in the configuration is subframe, which has a duration of 1 ms. The SMTC window duration may also be simply called as SMTC duration or SMTC length or SMTC occasion duration or SMTC occasion length etc.

The UE may use the same RF (Radio Frequency) module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, and the gap length can be configured from the value set {1.5, 3, 3.5, 4, 5.5, 6, 10, 20} ms. Usually, the measurement gap length is configured to be larger than the SMTC window duration to accommodate RF retuning time. A measurement gap time advance is also provided, which allows for fine tuning the relative position of the measurement gap with respect to the SMTC window. The measurement gap timing advance can be configured from the value set {0, 0.25, 0.5} ms. Different variants of SMTC are specified in 3GPP TS 38.331 V16.6.0 (2022 September).

In NTN deployments using higher frequency ranges, such as the FR2 frequency range above 24 GHz, performing measurements of the SSB typically requires receive (RX) beam sweeping by the UE to cover the possible directions of the satellites and correspondingly long SSB measurement time, e.g., in the range of 10 s or longer. During such time periods, the positions of the satellites may shift significantly, which may even result in the UE being out of coverage when the measurement ends. Further, when considering a handheld UE, there is also a risk that orientation of the UE changes over the measurement time, which may also impact the validity of the measurement results.

Accordingly, there is a need for efficiently measuring reference signals from satellites.

### SUMMARY

According to an embodiment, a method of controlling wireless communication in a wireless communication network is provided. According to the method, a wireless device applies a first measurement configuration for at least one first measurement on one or more reference signals from one or more satellites of a satellite radio access network of the wireless communication network. Further, the wireless device applies at least one second measurement configuration for at least one second measurement on the one or more reference signals from the one or more satellites of a satellite radio access network. The second measurement configuration is based on the at least one first measurement.

According to a further embodiment, a method of controlling wireless communication in a wireless communication network is provided. According to the method, a node of the wireless communication network configures a wireless device to apply a first measurement configuration for at least one first measurement on one or more reference signals from one or more satellites of a satellite radio access network of the wireless communication network. Further, the node configures the wireless device to apply at least one second measurement configuration for at least one second measurement on the one or more reference signals from the one or more satellites of a satellite radio access network, with the second measurement configuration being based on the at least one first measurement.

According to a further embodiment, a wireless device for operation in a wireless communication network is provided. The wireless device is adapted to apply a first measurement configuration for at least one first measurement on one or more reference signals from one or more satellites of a satellite radio access network of the wireless communication network. Further, the wireless device is adapted to apply at least one second measurement configuration for at least one second measurement on the one or more reference signals from the one or more satellites of a satellite radio access network. The second measurement configuration is based on the at least one first measurement.

According to a further embodiment, a wireless device for operation in a wireless communication network is provided. The wireless device comprises at least one processor and a memory. The memory contains instructions executable by said at least one processor, whereby the wireless device is operative to apply a first measurement configuration for at least one first measurement on one or more reference signals from one or more satellites of a satellite radio access network of the wireless communication network. Further, the memory contains instructions executable by said at least one processor, whereby the wireless device is operative to apply at least one second measurement configuration for at least one second measurement on the one or more reference signals from the one or more satellites of a satellite radio access network. The second measurement configuration is based on the at least one first measurement.

According to a further embodiment, a node for a wireless communication network is provided. The node is adapted to configure a wireless device to apply a first measurement configuration for at least one first measurement on one or more reference signals from one or more satellites of a satellite radio access network of the wireless communication network. Further, the node is adapted to configure the wireless device to apply at least one second measurement configuration for at least one second measurement on the one or more reference signals from the one or more satellites of a satellite radio access network, with the second measurement configuration being based on the at least one first measurement.

According to a further embodiment, a node for a wireless communication network is provided. The node comprises at least one processor and a memory. The memory contains instructions executable by said at least one processor, whereby the node is operative to configure a wireless device to apply a first measurement configuration for at least one first measurement on one or more reference signals from one or more satellites of a satellite radio access network of the wireless communication network. Further, the memory contains instructions executable by said at least one processor, whereby the node is operative to configure the wireless device to apply at least one second measurement configuration for at least one second measurement on the one or more reference signals from the one or more satellites of a satellite radio access network, with the second measurement configuration being based on the at least one first measurement.

According to a further embodiment, a computer program or computer program product is provided, e.g., in the form of a non-transitory storage medium, which comprises program code to be executed by at least one processor of a wireless device for operation in a wireless communication network. Execution of the program code causes the wireless device to apply a first measurement configuration for at least one first measurement on one or more reference signals from one or more satellites of a satellite radio access network of the wireless communication network. Further, execution of the program code causes the wireless device to apply at least one second measurement configuration for at least one second measurement on the one or more reference signals from the one or more satellites of a satellite radio access network. The second measurement configuration is based on the at least one first measurement.

According to a further embodiment, a computer program or computer program product is provided, e.g., in the form of a non-transitory storage medium, which comprises program code to be executed by at least one processor of a node for a wireless communication network. Execution of the program code causes the node to configure a wireless device to apply a first measurement configuration for at least one first measurement on one or more reference signals from one or more satellites of a satellite radio access network of the wireless communication network. Further, execution of the program code causes the node to configure the wireless device to apply at least one second measurement configuration for at least one second measurement on the one or more reference signals from the one or more satellites of a satellite radio access network, with the second measurement configuration being based on the at least one first measurement.

Details of such embodiments and further embodiments will be apparent from the following detailed description of embodiments.

### BRIEF DESCRIPTION OF THE DRAWINGS

FIG. 1 schematically illustrates usage of an SMTC for measurements of SSBs by a UE.

FIG. 2 schematically illustrates a wireless communication network according to an embodiment of the present disclosure.

FIG. 3 schematically illustrates a transparent payload architecture of an NTN, which may be used in embodiments of the present disclosure.

FIGS. 4A and 4B schematically illustrate representations of ephemeris data, which may be used in embodiments of the present disclosure.

FIG. 4C shows a table with values of propagation delay for different orbital heights and elevation angles of satellites.

FIG. 5 illustrates an example of a scenario in which measurements according to an embodiment of the present disclosure may be applied.

FIG. 6 illustrates an angular distances of satellite from the perspective of a UE on the surface of the earth.

FIG. 7 schematically illustrates an example of collecting samples based on measurement configurations according to an embodiment of the present disclosure.

FIGS. 8A and 8B schematically illustrates an example of beam sweeping based measurements according to an embodiment of the present disclosure.

FIG. 9 schematically illustrates a further example of collecting samples based on measurement configurations according to an embodiment of the present disclosure.

FIGS. 10A and 10B schematically illustrates a further example of beam sweeping based measurements according to an embodiment of the present disclosure.

FIGS. 11A and 11B schematically illustrates a still further example of beam sweeping based measurements according to an embodiment of the present disclosure.

FIG. 12 shows a flowchart for schematically illustrating a method according to an embodiment.

FIG. 13 shows a flowchart for schematically illustrating a further method according to an embodiment.

FIG. 14 schematically illustrates structures of a wireless device according to an embodiment.

FIG. 15 schematically illustrates structures of a network node according to an embodiment.

FIG. 16 schematically illustrates a virtualization environment according to an embodiment.

FIG. 17 schematically illustrates interaction of a host and a wireless device according to an embodiment.

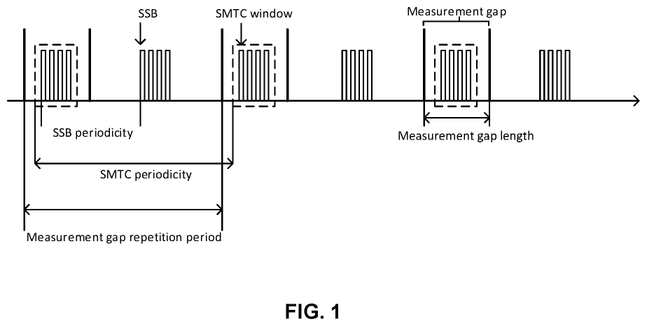

### DETAILED DESCRIPTION

In the following, concepts in accordance with exemplary embodiments of the present disclosure will be explained in more detail and with reference to the accompanying drawings. The illustrated embodiments relate to control of wireless communication in a wireless communication network, in particular to management of measurements of reference signals from satellite-based nodes of the wireless communication network. The wireless communication network may for example be a cellular network, e.g., as specified by 3GPP. The wireless communication may then for example be based on the NR technology, the LTE technology, or a future 6G (6th Generation) technology, which supports wireless connectivity via satellite based network nodes.

As used herein, the term “wireless device” or user equipment (UE) refers to a device capable, configured, arranged, and/or operable to communicate wirelessly with network nodes and/or other UEs. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a Voice over IP (VoIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a UE may also represent a machine or other device that performs monitoring and/or measurements, and transmits the results of such monitoring and/or measurements to another UE and/or a network node. The UE may in this case be a Machine-to-Machine (M2M) device, which may in a 3GPP context be referred to as a Machine-Type Communication (MTC) device. As one particular example, the UE may be a wireless device implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

In the illustrated concepts, a measurement configuration applied by a wireless device when performing measurements on one or more reference signals from satellites may be determined in an adaptive manner. Specifically, the wireless device may apply a first measurement configuration when performing a first measurement the reference signal(s) and then determine a second measurement configuration based on the first measurement. The wireless device then applies the second measurement configuration when performing a second measurement on the reference signal(s). The reference signal may include SSBs, and the measurement configurations may be based on one or more SMTCs. In some scenarios, the first measurement configuration may correspond to a first SMTC and the second measurement configuration may correspond to a second SMTC. In other scenarios, the first measurement configuration may apply to a first set of one or more samples measured within an SMTC, and the second measurement configuration to a second set of one or more samples measured within the SMTC. The first set of samples and the second set of samples may for example correspond to different RX beam sweeps in the SMTC. The first measurement may be used for determining relative position information of the satellites and the wireless device, e.g., ephemeris data of the satellites, satellite-based position of the wireless device, and/or orientation of the wireless device with respect to the satellites. The wireless device may then adapt the second measurement configuration to the acquired position information, so that the second measurement can be performed within shorter time and/or with higher accuracy.

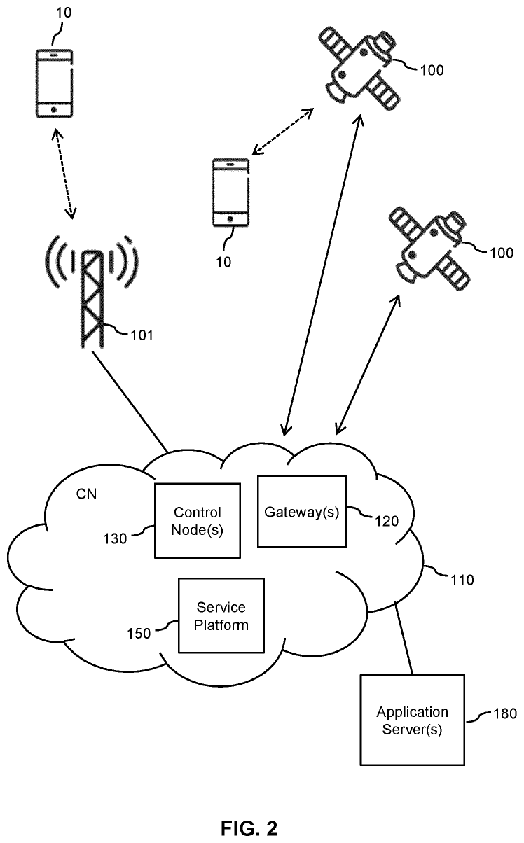

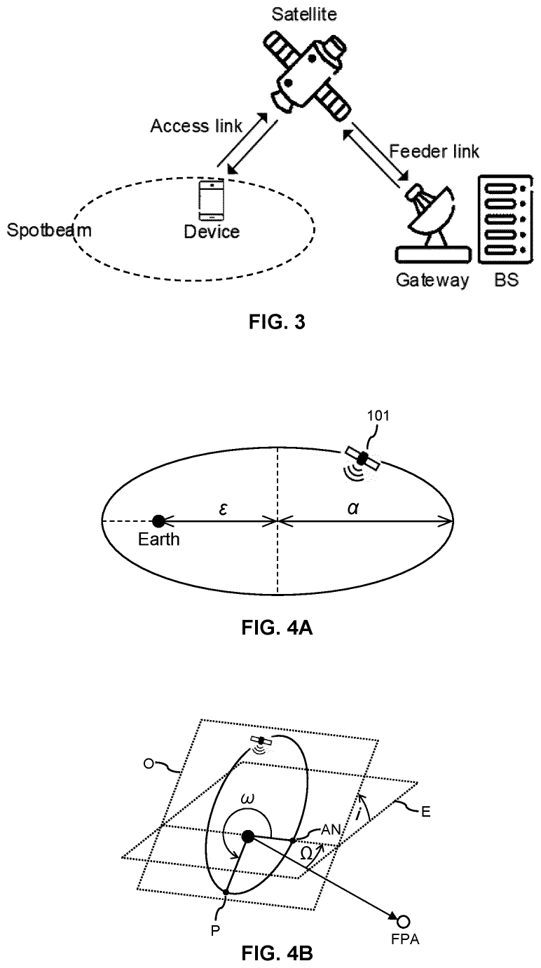

FIG. 2 illustrates exemplary structures of the communication network, which in the illustrated example is assumed to be a wireless communication network as specified by 3GPP. In particular, FIG. 2 shows multiple UEs 10 which are served by access nodes 100, 101 of the wireless communication network. Here, it is noted that the access nodes 100, 101 may each serve a number of cells within the coverage area of the wireless communication network. The access nodes 100, 101 may for example each correspond to a gNB of the NR technology or to an eNB of the LTE technology. As illustrated, some of the access nodes 100 are satellite-based. Such access nodes 100 are herein also simply denoted as satellite. It is however noted that a part of the functionality of such satellite-based access node 100 could be located in a terrestrial node. FIG. 3 illustrates an example of such distributed architecture of a satellite-based access node 100. The satellites 100 may be regarded as an NTN access of the wireless communication network. As further illustrated, the wireless communication network may also include terrestrial access nodes 101, which may be regarded as being as a TN access of the wireless communication network.

Further, FIG. 2 schematically illustrates a CN (Core Network) 110 of the wireless communication network. In FIG. 2, the CN 110 is illustrated as including one or more gateways 120 and one or more control node(s) 130. The gateway 120 may be responsible for handling user plane traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The control node(s) 130 may be used for controlling the user data traffic, e.g., by providing control data to the base stations 100, the gateway 120, and/or to the UE 10.

As illustrated by double-headed arrows, the access nodes 100, 101 may send downlink (DL) transmissions to the UEs, and the UEs may send uplink (UL) transmissions to the access nodes 100, 101. The DL transmissions and UL transmissions may be used to provide various kinds of services to the UEs, e.g., a voice service, a multimedia service, or a data service. Such services may be hosted in the CN 110, e.g., by a corresponding network node. By way of example, FIG. 2 illustrates a service platform 150 provided in the CN 110. Further, such services may be hosted externally, e.g., by an AF (application function) connected to the CN 110. By way of example, FIG. 2 illustrates one or more application servers 180 connected to the CN 110. The application server(s) 180 could for example connect through the Internet or some other wide area communication network to the CN 110. The service platform 150 may be based on a server or a cloud computing system and be hosted by one or more host computers. Similarly, the application server(s) 180 may be based on a server or a cloud computing system and be hosted by one or more host computers. The application server(s) 180 may include or be associated with one or more AFs that enable interaction with the CN 110 to provide one or more services to the UEs 10, corresponding to one or more applications. These services or applications may generate the user plane data traffic conveyed by the DL transmissions and/or the UL transmissions between the base station 100 and the respective UE 10. Accordingly, the application server(s) 180 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the user plane traffic between the UE 10 and the base station 100.

An NTN access as considered in the illustrated concepts may include at least some of the following components: the actual satellite, which constitutes a space-borne platform for wireless transmission of data to or from the UE 10; an earth-based gateway that connects the satellite to a terrestrial access node or to the CN 110; a link between the gateway and the satellite, typically denoted as “feeder link”; and a link between the satellite and the UE 10, typically denoted as “access link” or service link. Depending on orbit altitude, the satellite may be categorized as LEO satellite, GEO satellite, or MEO (medium earth orbit) satellite. Typical orbit altitudes of LEO satellites range from 250 to 1,500 km, with orbital periods ranging from 90 to 120 minutes. Typical orbit altitudes of MEO satellites range from 5,000 to 25,000 km, with orbital periods ranging from 3 to 15 hours. Typical orbit altitudes of GEO satellites are at about 35,786 km, with an orbital period of 24 hours.

The NTN access can be based on either a transparent payload architecture (also referred to as bent pipe architecture) or on a regenerative payload architecture. In the case of the transparent payload architecture, the satellite forwards the received signal between the UE and a network node on the ground, with signal processing being limited to amplification and a shift of frequency between the access link and the feeder link. In terms of the typical 3GPP architecture and terminology, the transparent payload architecture means that in principle the gNB/eNB is located on the ground and the satellite acts as a remote radio head for forwarding signals between the gNB/eNB and the UE 10. FIG. 3 schematically illustrates the transparent architecture. The typical functionalities of a base station (BS), e.g., of a gNB or an eNB, may be integrated in the gateway, or the BS may be connected to the gateway via a terrestrial connection, e.g., based on wire, optic fiber, or wireless. In the case of the regenerative payload architecture, the satellite performs on-board processing to demodulate and decode the received signals and to regenerate the signals before sending the signals back to earth. In terms of the typical 3GPP architecture and terminology, this would mean that the gNB/eNB is located in the satellite.

A satellite as considered herein typically generate several beams over a given area. The coverage footprint of a beam usually has an elliptic shape. The coverage footprint of the beam or the aggregated coverage footprints of multiple beams from the satellite may be regarded as a cell. The coverage footprint of a beam may also be referred to as a spotbeam. The coverage footprint of a beam may move over the earth's surface with the satellite movement or may be held stationary on the earth's surface by means of a beam steering mechanism of the satellite to compensate for the satellite's motion. The latter type of beam may be referred to as quasi-earth-fixed beams or quasi-earth-fixed cells. The size of a spotbeam may range from tens of kilometers to a few thousands of kilometers.

In accordance with 3GPP TR 38.821 V16.1.0 (2021 May), the illustrated concepts may involve that ephemeris data is provided to the UE 10, e.g., with the aim of assisting the UE 10 in pointing an antenna beam towards the satellite. If the UE 10 knows its own geographical position, e.g., from a GNSS (Global Navigation Satellite System), support the UE 10 may combine this with the ephemeris data to correct timing and/or frequency drifts, e.g., in terms of Timing Advance (TA) and/or Doppler shift.

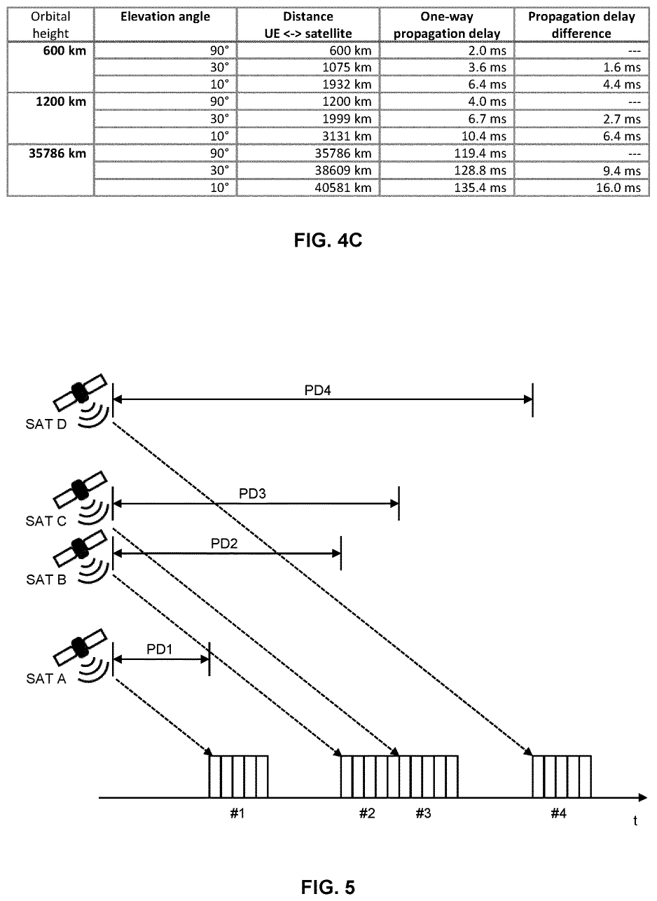

A satellite orbit can be fully described using six parameters, with different specific representations being possible. For example, a set of parameters often used in astronomy is the set (a, ε, i, Ω, ω, t). Here, the semi-major axis a, and the eccentricity ε describe the shape and size of the orbit ellipse; the inclination i, the right ascension of the ascending node Ω, and the argument of periapsis ω determine its position in space, and the epoch t determines a reference time, e.g., the time when the satellites moves through periapsis. These parameters are schematically illustrated in FIGS. 4A and 4B. A two-line element set (TLE) is a data format encoding a list of orbital elements of an Earth-orbiting object for a given point in time, the epoch. As an example of a different parametrization, TLEs use mean motion n and mean anomaly M instead of a and t. A still further set of parameters is the position and velocity vector (x, y, z, vₓ, v_{y}, v_{z}) of a satellite. Such sets of parameters are also referred to as orbital state vectors. They can be derived from the orbital elements and vice versa since the information they contain is equivalent. In the illustrated concepts, any of these representations or combinations thereof may be used for representing the ephemeris data of a satellite. Such ephemeris data may be supplemented with information on possible coverage area and/or timing information indicating when the satellite is going to serve a certain geographical area on the earth's surface.

In a LEO or MEO communication system, a large number of satellites deployed over a range of orbits may be required to provide continuous coverage across the full globe. Launching a mega satellite constellation is both an expensive and time-consuming procedure. It can therefore ne expected that at least for some time LEO and MEO satellite constellations provide only partial earth-coverage. In case of some constellations dedicated to massive IoT services with relaxed latency requirements, it may not even be necessary to support full earth-coverage. Rather, it may be sufficient to provide occasional or periodic coverage according to the orbital period of the constellation.

A 3GPP device in RRC_IDLE or RRC_INACTIVE state typically needs to perform a number of procedures, such as measurements for mobility purposes, paging monitoring, logging measurement results, tracking area update, and search for a new PLMN (Public Land Mobile Network). Such procedures contribute to power consumption of the device. In some scenarios, requirements on such procedures may be relaxed to prolong battery life of the device. Such measures may for example be beneficial in the case of certain IoT devices, such as reduced capability (redcap), NB IoT, or LTE M devices.

Propagation delay is an important aspect of satellite communications that is different from the delay expected in a terrestrial mobile system. For the above-mentioned transparent payload architecture, the round-trip delay between UE network may, depending on the orbit height, range from tens of milliseconds in the case of LEO satellites to several hundreds of milliseconds for GEO satellites. As a comparison, the round-trip delays in terrestrial cellular networks are typically below 1 ms.

The distance between the UE 10 and the satellite 100 can vary significantly, depending on the position of the satellite 100 and thus the elevation angle & seen by the UE 10. Assuming circular orbits, the minimum distance occurs when the satellite is directly above the UE (s=90°), and the maximum distance occurs when the satellite is at the smallest possible elevation angle.

FIG. 4C shows a table with distances between satellite and UE for different orbital heights and elevation angles together with the one-way propagation delay and the maximum propagation delay difference (the difference from the propagation delay at ε=90°). It is noted that the values in the table assume usage of a regenerative payload architecture. For the transparent payload architecture, there is typically an additional delay contribution due to the feeder link between gateway and satellite. The propagation delay may also be highly variable. For example, due to high velocity of LEO and MEO satellites, the propagation delay may change in the order of 10 to 100 μs over a time interval of one second. The degree and characteristics of such variations depends on the orbit altitude and satellite velocity.

As can be seen from above, the illustrated concepts may consider scenarios where a at least one UE 10 is served in a certain cell of the wireless communication network, which is managed by a certain access node 100, 101. This cell may also be denoted as “serving cell” of the UE 10. For purposes of mobility management, e.g., handover or cell-reselection, the UE 10 may perform one or more measurements on reference signals of one or more other cells. At least some of these reference signals may be transmitted by satellites, e.g., the satellites 100. The cells may be served on different carrier frequencies.

For performing the measurements, the UE 10 may be configured with at least two SMTCs per measurement object (MO) or per carrier frequency for at least one MO or for at least one carrier frequency. The term carrier frequency may also be denoted as carrier frequency layer, carrier, or layer. Information about the carrier frequency may be indicated to the UE 10 in a MO definition, e.g., in terms of frequency channel number such as ARFCN (Absolute Radio Frequency Channel Number) or NR-ARFCN. One or more cells may belong to or operate on the indicated carrier frequency. The number of SMTCs per MO configured in a cell may vary.

Each SMTC indicated to the UE 10 in a MO is associated with corresponding SMTC parameters. These parameters for example an include SMTC index (or SMTC identifier), which is typically an integer number, i.e., 1, 2, 3, 4. Further, these parameters typically include SMTC duration, SMTC periodicity, and time offset of SMTC. Further, a reference signal configuration may include parameters like reference signal index (or reference signal identifier), typically an integer number, i.e., 1, 2, 3, 4, . . . , reference signal duration, reference signal periodicity, time offset of reference signal, or the like. Multiple SMTCs may be enabled by using different time offsets:

Two or more SMTCs are herein considered as at least partly overlapped in time provided that their SMTC durations at least partly overlap in time. Such SMTCs are herein also denoted as partially overlapping SMTC configurations. Further, two or more SMTCs are herein considered as fully overlapped in time provided that their SMTC durations fully overlap in time. Such SMTCs are herein also denoted as fully overlapping SMTC configurations. When SMTC durations of two or more SMTCs have no overlap in time, they are herein also denoted as non-overlapping SMTCs.

FIG. 5 schematically illustrates an example of a scenario involving configuration of multiple SMTCs per MO. In the example of FIG. 4, the UE 10 is configured with four different SMTCs, each corresponding to one of four different satellites, denoted as “SAT A”, “SAT B”, “SAT C”, and “SAT D”, respectively. These SMTCs are configured by the access node 100, 101 currently serving the UE 10, using RRC signaling. SMTC #1 corresponds to satellite SAT A, and the reference signals from satellite SAT A have a first propagation delay, denoted as PD 1. SMTC #2 corresponds to satellite SAT B, and the reference signals from satellite SAT B have a second propagation delay, denoted as PD 2. SMTC #3 corresponds to satellite SAT C, and the reference signals from satellite SAT C have a third propagation delay, denoted as PD 3. SMTC #4 corresponds to satellite SAT D, and the reference signals from satellite SAT D have a fourth propagation delay, denoted as PD 4. In this example, SMTC #1 and SMTC #4 do not overlap in time. SMTC #2 and SMTC #3 partly overlap in time, due to different time offsets.

In the illustrated concepts, the UEs 10 may apply adaptively determined measurement configurations for measurements of reference signals from the satellites 100. In the following explanations, it will be assumed that the reference signals correspond to SSBs and the measurement configurations correspond to SMTCs. The adaptation may be performed locally at the UE 10. Rules for performing the adaptation may however be configured by the network, e.g., by the gNB. Further, at least a part of such rules could also be pre-configured in the UE 10, e.g., based on standardization or operator settings. It is noted that the illustrated concepts could be applied in a corresponding manner to other types of reference signals. Examples of such reference signal (RS) include PSS, SSS, CSI-RS (Channel State Information RS, DMRS (Demodulation RS), DRS (Discovery Reference Signal), CRS (Cell Specific Reference Signal), and PRS (Positioning Reference Signal). The reference signals may be periodic, e.g., an RS occasion carrying one or more reference signals may occur with certain periodicity of for example 20 ms, 40 ms, or the like. The reference signals may also be aperiodic. The reference signals may be transmitted in various kinds of physical channels carrying higher layer information, such as user data, control data, or the like. Examples of such physical channels in the NR technology are PBCH, NPBCH (Narrowband PBCH), PDCCH (Physical DL Control Channel), PDSCH (Physical DL Shared Channel), sPDSCH (short PDSCH), MPDCCH (Machine Type Communication PDCCH), NPDCCH (Narrowband PDCCH), NPDSCH (Narrowband PDSCH), E-PDCCH (Enhanced PDCCH), or the like.

In scenarios as further detailed below, the reference signals are assumed to include SSBs. Each SSB may carry NR-PSS, NR-SSS and NR-PBCH in 4 successive symbols. One or multiple SSBs may be transmitted in one SSB burst which is repeated with certain periodicity of for example 5 ms, 10 ms, 20 ms, 40 ms, 80 ms and 160 ms. The UE is configured with information about SSB on cells of certain carrier frequency by one or more SMTCs. The SMTCs include parameters like SMTC periodicity, SMTC occasion length in time or duration, and/or SMTC time offset with respect to a reference time, such as the serving cell's SFN (Subframe Number). An SMTC occasion may also occur with certain periodicity of for example 5 ms, 10 ms, 20 ms, 40 ms, 80 ms, or 160 ms. Further details of the SMTCs may be as specified in 3GPP TS 38.331 V16.6.0 (2022 September).

In some scenarios, the adaptation of the SMTCs may involve that the RX beam sweeping configuration for one SMTC is determined based on RX beam sweeping measurements performed based on another SMTC. When for example assuming that the UE 10 is configured with a number of n SMTCs, denoted as SMTC #1, . . . , SMTC #n, the RX beam sweeping configuration for SMTC #y could be determined on the RX beam sweeping measurements performed for SMTC #x, with x and y being different integers selected from the interval [1, . . . , n]. Based on the RX beam sweeping measurements for SMTC #y, the UE 10 could for example acquire ephemeris data of satellites, a GNSS position, and optionally orientation of the UE 10, and then utilize this information for adapting the RX beam sweeping configuration for SMTC #y. Such adaptation may for example involve reducing the number of sweeps and/range of sweeps to limit the RX beam sweeping to directions where satellites are expected based on the acquired ephemeris data and GNSS position, and optionally orientation. For example, the UE 10 could first perform RX beam sweeping over N1 beams for SMTC #1, and then subsequently RX beam sweeping over N2 beams for SMTC #2, RX beam sweeping over N3 beams for SMTC #3, and RX beam sweeping over N4 beams for SMTC #4, with the RX beam sweeping configuration, e.g., N2, N3, and N4, for SMTC #2, #3, and #4 being based on the information acquired from the measurements based on SMTC #1.

In some scenarios, the UE 10 may apply multiple measurement configurations within the same SMTC. Specifically, the UE 10 could apply a first measurement configuration when performing measurements to obtain a first set of one or more samples and then apply a second measurement configuration to obtain a second set of one or more samples. The first measurement configuration may include a first RX beam sweeping configuration, while the second measurement configuration includes a second RX beam sweeping configuration. Based on the RX beam sweeping measurements for the first set of samples, the UE 10 could for example acquire ephemeris data of satellites, a GNSS position, and optionally orientation of the UE 10, and then utilize this information for adapting the RX beam sweeping configuration for the second set of samples. Such adaptation may for example involve reducing the number of sweeps and/range of sweeps to limit the RX beam sweeping to directions where satellites are expected based on the acquired ephemeris data and GNSS position, and optionally orientation. For example, the UE 10 could first perform M1 RX beam sweeps for a first sample of SMTC #1. Subsequently, the UE 10 could perform M2 RX beam sweeps for a second sample and optionally further samples of SMTC #1 until the UE 10 has completed measurement for all samples for SMTC #1, with the RX beam sweeps for the second and optional further samples being based on the information acquired from the measurements of the first sample.

In some scenarios, SMTCs configured for the UE 10 may be partially or fully overlapping. In such cases, the UE 10 may determine based on a rule or a set of rules whether to complete the measurements for the overlapping SMTC in each SMTC period. When for example assuming that the UE 10 is configured with a number of n SMTCs, denoted as SMTC #1, . . . , SMTC #n, the RX beam sweeping configuration for SMTC #y could partially or fully overlap with SMTC #x, with x and y being different integers selected from the interval [1, . . . , n]. Then, the considered rule could specify that the UE 10 completes the measurements for both SMTC #x and SMTC #y if the parameters SSB-ToMeasure of SMTC #x and SSB-ToMeasure of SMTC #y are separated in time by more than a time threshold Δ. Values of the time threshold could for example be time threshold Δ=1 symbol duration, time threshold Δ=1 slot duration (0.125 ms) for SCS=120 kHz, or time threshold Δ=1 subframe duration.

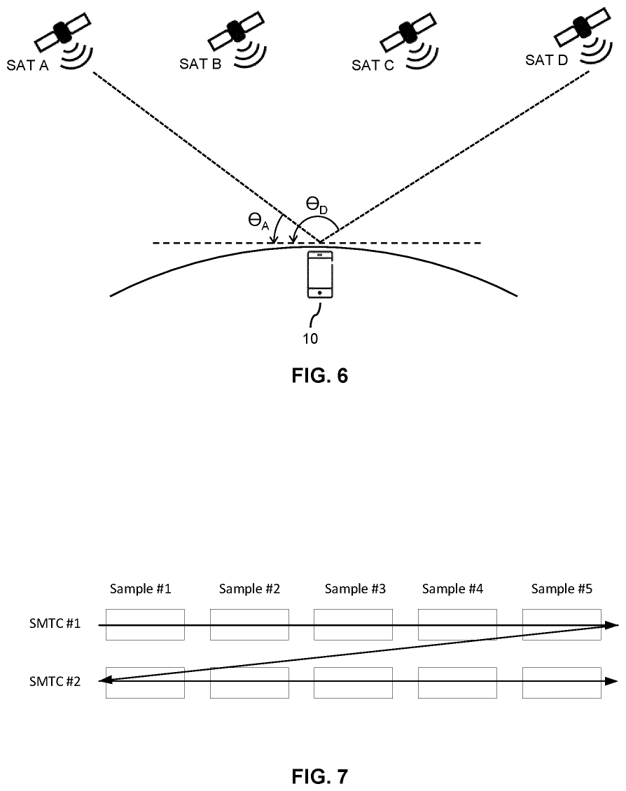

As mentioned above, the UE 10 may acquire ephemeris data of satellites 100 of its serving cell and neighbor cells. Further, the UE 10 may acquire position information, e.g., the UE's 10 GNSS position and optionally information on angular orientation of the UE 10. FIG. 6 schematically illustrates a maximal range of angular distance of satellites from the perspective of the UE 10, i.e., when considering an observation reference point located at the UE 10. As can be seen, the difference between the elevation angles of any two different satellites, e.g., θ_{D}−θ_{A}, in FIG. 6, is limited to typically 120°. When considering this limitation together with known trajectories of satellites, the UE 10 can at least roughly track the angular distance of different satellites and distinguish between them. As a result, when the UE 10 has performed a full RX beam sweep of 360° to detect the first satellite, a further full beam sweep is not needed to detect the next satellite(s). Rather, such subsequent sweeps may be limited to the range of the above maximum offset in elevation angle e.

The UE 10 may determine whether two SMTCs are too close to each other in time. For this purpose the UE 10 may apply an SMTC close distance (SCD) rule. When two SMTCs are found to be close to each other, the UE can adapt the RX beam sweeping of these SMTCs based on SMTC beam similarity rules. In this way, the RX beam sweeping may be shortened, e.g., by using a smaller scaling factor.

For considering the closeness of a first SMTC and a second SMTC, the SCD rule can be based on one or more metrics or parameters and one or more thresholds. For example, the SCD rule can be based on comparing the time difference between the start time T11 of the first SMTC and the start time T21 of the second SMTC to a threshold TH1. Alternatively or in addition, the SCD rule can be based on comparing the time difference between the start time T11 of the first SMTC and the end time T22 of the second SMTC to a threshold TH2. Alternatively or in addition, the SCD rule can be based on comparing the time difference between the end time T12 of the first SMTC and the end time T22 of the second SMTC to a threshold TH3. Alternatively or in addition, the SCD rule can be based on comparing the time difference between the end time T12 of the first SMTC and the start time T21 of the second SMTC to a threshold TH3.

The SMTC beam similarity rules may involve that, if the UE performs RX beam sweeping with N1 beams the first SMTC, the UE 10 limits the RX beam sweeping for the second SMTC to N2 beams. For example, when for any among the N2 RX beam sweeping measurements on SMTC #2 the UE 10 detects a signal quality that exceeds a threshold S_TH1, the UE 10 may adopt one or more RX beams among the N2 RX beams as RX beam (or RX beam index) dedicated for the second SMTC and SSB(s) in the second SMTC. Alternatively or in addition, when for all of the N2 RX beam sweeping measurements on SMTC #2 the UE 10 detects UE 10 detects a signal quality that exceeds a threshold S_TH2, UE 10 may adopt one or more RX beams among the N2 RX beams as RX beam (or RX beam index) dedicated for the second SMTC and SSB(s) in the second SMTC. These rules may be extended in a corresponding manner for more than two SMTCs.

Further, the SMTC beam similarity rules may involve that, if the UE performs RX beam sweeping with N1 beams for a first sample of an SMTC, the UE 10 limits the RX beam sweeping for the second sample of the SMTC to N2 beams. For example, when for any among the RX beam sweeping measurements for a second sample in a certain SMTC the UE 10 detects a signal quality that exceeds a threshold S_TH5, the UE 10 may adopt one or more RX beams among the RX beams as RX beam (or RX beam index) dedicated for the measurements of the second sample. Alternatively or in addition, when for all of the RX beam sweeping measurements for a second sample in a certain SMTC the UE 10 detects a signal quality that exceeds a threshold S_TH6, the UE 10 may adopt one or more RX beams among the RX beams as RX beam (or RX beam index) dedicated for the measurements of the second sample. In the above rules, the signal quality may be based on of RSRP (Reference Signal Received Power), RSSI (Received Signal Strength Indicator), SINR (Signal to Interference plus Noise), or similar metrics. These rules may be extended in a corresponding manner for more than two samples within an SMTC.

The above adaption of RX beam sweeping may for example be applied in scenarios where the propagation channel to the UE 10 is subject to no or only negligible changes between two measurement instances, so that the UE 10 can assess beam similarity based on previous measurement results.

When the UE 10 identified the best RX beam of a first SMTC, the information the UE 10 acquires based on this RX beam can be used as refence for RX beam sweeping of the second SMTC. The UE 10 may acquires identifier(s) of satellite(s) and cell(s) for all SMTCs through information indicated by broadcasted system information, e.g., in an SIB (System Information Block) and/or indicated by RRC signaling, e.g., in an information element (IE) denoted as “measconfig”. Based on the acquired information, the UE 10 can identify the elevation angles of the satellite(s) covered in the first SMTC and also distinguish the offset between elevation angles of theses satellite(s) and elevation angles of the satellite(s) covered in the second SMTC.

In the above concepts will be further illustrated by referring to specific examples. These examples involve partial overlapping of two SMTCs. It is however noted that the concepts would similarly work for non-overlapping SMTCs.

FIG. 7 illustrates a first example of a measurement sequence for the first SMTC (SMTC #1) and the second SMTC (SMTC #2). In this example, the UE 10 first performs N1=8 RX beam sweeping measurements for SMTC #1 and subsequently N2 RX beam sweeping measurements for SMTC #2. If the two SMTCs meet the SCD rule, i.e., are found to be sufficiently close to each other, the UE 10 can limit the N2 RX beam sweeping measurements to a lower number than N1, e.g., to N2=3. For example, some of the RX beams covered by the measurements for SMTC #1, could already capture one or more of the satellite(s) to be covered by SMTC #2. Accordingly, the UE 10 only needs to perform N2 (<N1) RX beam sweeping measurements for SMTC #2.

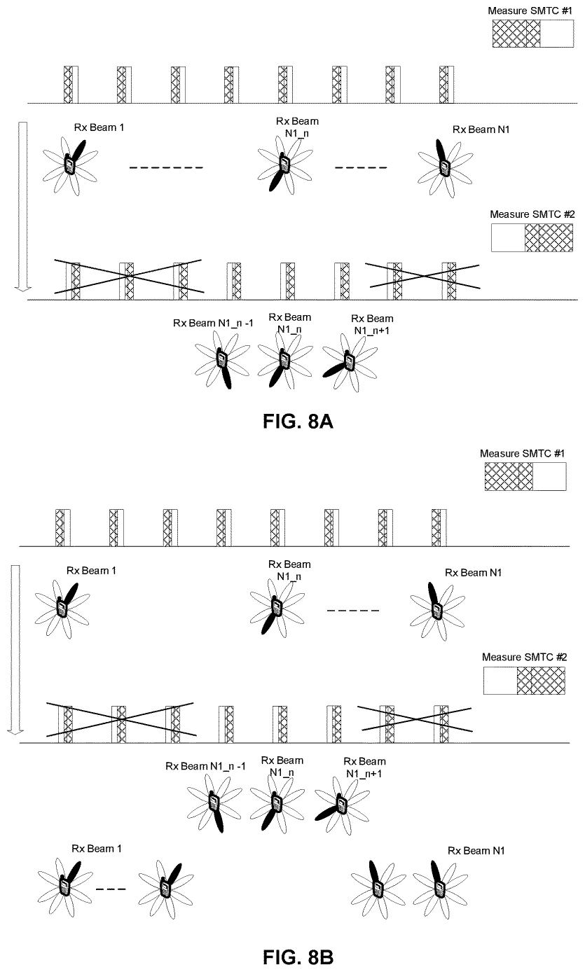

In some scenarios, a recovery mechanism may be applied to improve robustness in case of detection failure, for example if for some reason the RX beam sweeping for SMTC #1 fails to provide measurement results that can be used for optimizing the measurements for the SMTC #2. FIGS. 8A and 8B show an example for illustrating operation of such recovery mechanism. In this mechanism, the UE 10 may detect that for none of the N2 RX beam sweeping measurements for SMTC #2 the signal quality exceeds a threshold S_TH3. The UE 10 thus decides to continue with collecting the samples of the remaining RX beam sweeping measurements possible in SMTC #2. Alternatively or in addition, the UE 10 could detect that not for all the N2 RX beam sweeping measurements for SMTC #2 the signal quality exceeds a threshold S_TH4 and, in response, decide to continue with collecting the samples of the remaining RX beam sweeping measurements possible in SMTC #2. FIG. 8A illustrates the initially planned measurement sequence, and FIG. 8B the measurement sequence used in the recovery.

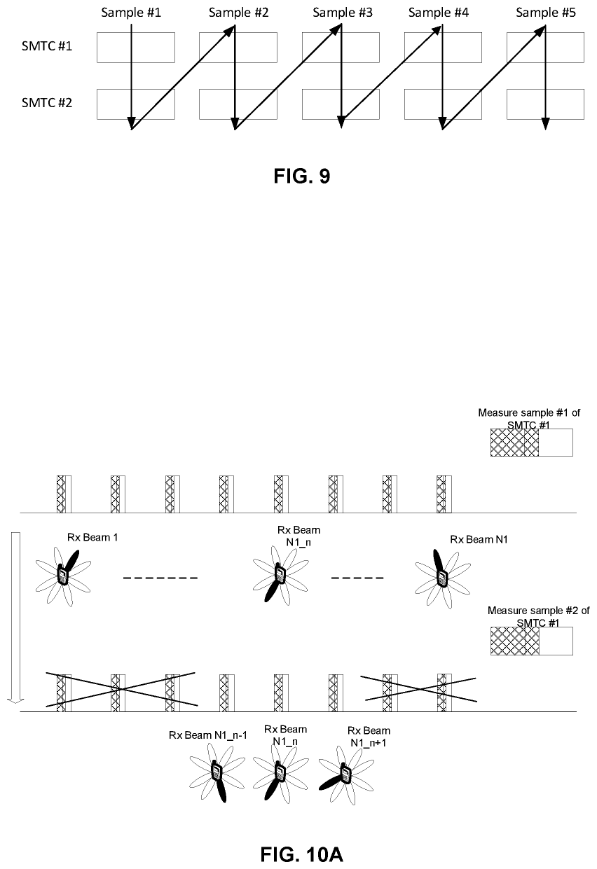

FIG. 9 illustrates a second example of a measurement sequence for the first SMTC (SMTC #1) and the second SMTC (SMTC #2). In this example, the UE 10 first performs N1=8 RX beam sweeping measurements for a first sample (sample #1) of SMTC #1 and then RX beam sweeping measurements for a first sample (sample #1) of SMTC #2. The UE 10 then continues with preforming N2 RX beam sweeping measurements for a second sample (sample #2) of SMTC #1 and then RX beam sweeping measurements for a second sample (sample #2) of SMTC #2. For the next samples, the UE 10 continues in a similar manner by alternatingly performing RX beam sweeping measurements for SMTC #1 and SMTC #2. In this case, the UE 10 can limit the N2 RX beam sweeping measurements for sample #2 to a lower number than N1, e.g., to N2=3. For example, some of the RX beams covered by the measurements for sample #1 could already capture RX beams of sample #2, e.g., due to relatively constant position of the satellites and constant orientation of the UE 10. Accordingly, the UE 10 only needs to perform N2 (<N1) RX beam sweeping measurements for sample #2 of SMTC #1.

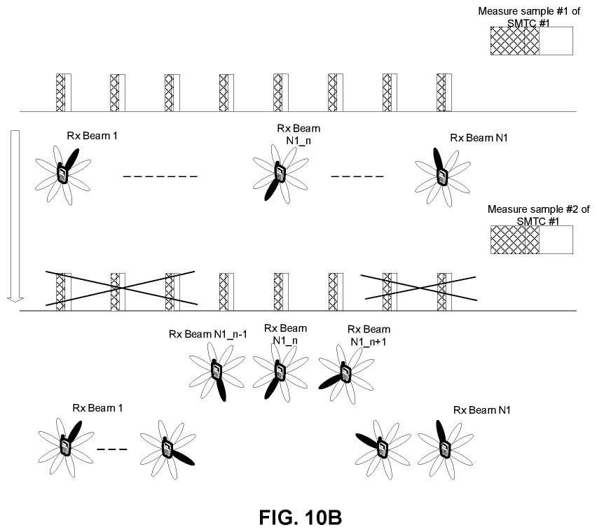

Also when using a measurement sequence with measurements alternating between samples for SMTC #1 and SMTC #2, a recovery mechanism may be applied to improve robustness in case of detection failure, for example if for some reason the RX beam sweeping measurements for sample #1 fail to provide measurement results that can be used for optimizing the measurements for sample #2. FIGS. 10A and 10B show an example for illustrating operation of such recovery mechanism. In this mechanism, the UE 10 may detect that for none of the N2 RX beam sweeping measurements for sample #2 the signal quality exceeds a threshold S_TH7. The UE 10 thus decides to continue with collecting the samples of the remaining RX beam sweeping measurements possible for sample #2. Alternatively or in addition, the UE 10 could detect that not for all the N2 RX beam sweeping measurements for sample #2 the signal quality exceeds a threshold S_TH8 and, in response, decide to continue with collecting the samples of the remaining RX beam sweeping measurements possible for sample #2. FIG. 10A illustrates the initially planned measurement sequence, and FIG. 10B the measurement sequence used in the recovery.

The difference in the measurement sequence of the first example (FIG. 7) and the measurement sequence of the second example (FIG. 9) is that in the first example the UE 10 performs measurements for all samples of one SMTC first then for all samples of the next SMTC, while in the second example the UE 10 performs measurements for one sample of all SMTC first and then continues with the next sample. It is however noted that these two types of measurement sequences have the purpose of illustrating possible ways of sequencing through the measurements of multiple SMTCs. In practice, it would also be possible to combine the two measurement sequence types, e.g., by first proceeding sample-wise as illustrated in FIG. 9 and then continuing SMTC-wise to complete the remaining measurements for each SMTC.

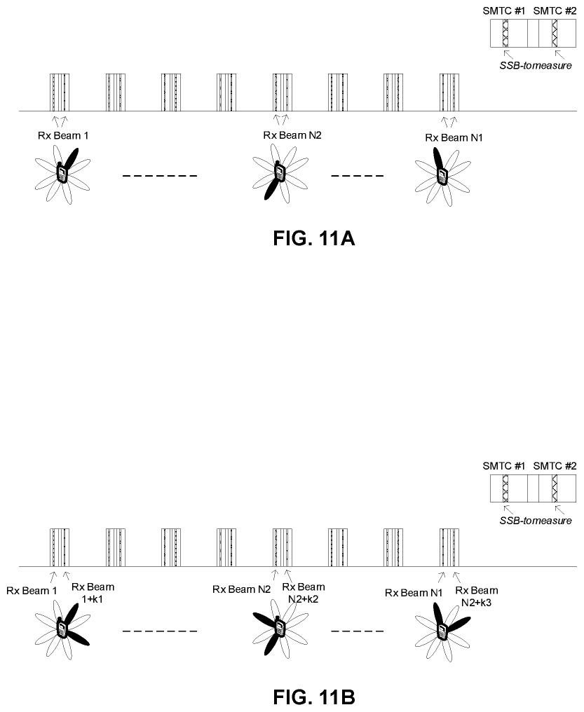

In some scenarios, the UE 10 may complete measuring certain SMTCs, e.g., at least SMTC #x and SMTC #y, in each SMTC periodicity even when there is partial overlapping between these SMTCs or overlapping of these SMTCs with one or more other SMTCs. As mentioned above, such selective completion may be controlled based on one or more rules. FIGS. 11A and 11B illustrate a corresponding example.

The scenario of FIG. 11A assumes that the UE 10 is configured with two SMTCs, denoted as SMTC #1 and SMTC #2. The UE 10 measures SMTC #1 and SMTC #2 simultaneously in one SMTC occasion, i.e., within one SMTC periodicity, with one RX beam. This may be possible because the offset in elevation angle between the satellite(s) covered in SMTC #1 and the satellites(s) covered in SMTC #2 is less than a threshold A_TH1. As compared to that, the scenario of FIG. 11B assumes that the offset in elevation angle between the satellite(s) covered in SMTC #1 and the satellites(s) covered in SMTC #2 is above a threshold A_TH2. As compared to the scenario of FIG. 11A, the UE 10 may switch the RX beam between receiving SSBs in SMTC #1 and SMTC #2. In the scenarios, of FIGS. 11A and 11B, an example of a rule to be applied for controlling the selective completion is that the UE 10 completes the measurements for SMTC #1 and SMTC #2 if the SSB-ToMeasure of SMTC #1 and SSB-ToMeasure of SMTC #2 are separated in time by more than the threshold T_TH1. As mentioned above, the value of T_TH1 could for example be T_TH1=1 symbol duration, T_TH 1=1 slot duration (0.125 ms) for SCS=120 kHz, or T_TH 1=1 subframe duration. Another example of a rule to be applied for controlling the selective completion is that the UE 10 completes the measurements for SMTC #1 and SMTC #2 if the union of SSB-ToMeasure of SMTC #1 and SSB-ToMeasure of SMTC #2 in time is less than a threshold T_TH2. The value of the threshold T_TH2 could for example be T_TH2=0.5 ms for SCS=120 KHz or T_TH2=4 subframes duration.

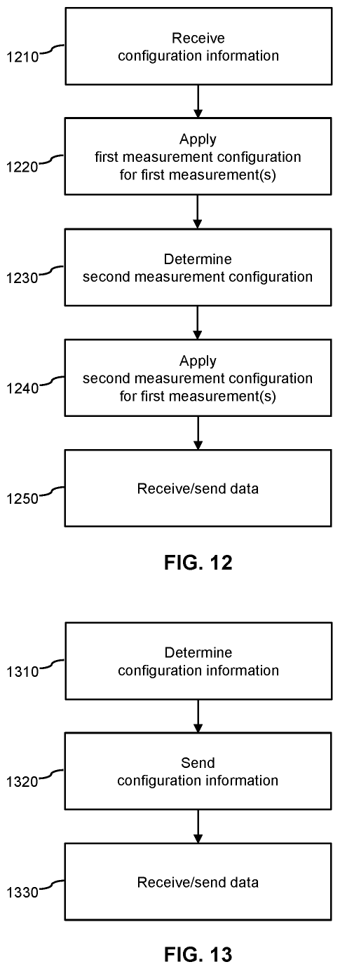

FIG. 12 shows a flowchart for illustrating a method, which may be utilized for implementing the illustrated concepts. The method of FIG. 12 may be used for implementing the illustrated concepts in wireless device for operation in a wireless communication network, e.g., corresponding to one of the above-mentioned UEs 10.

If a processor-based implementation of the wireless device is used, at least some of the steps of the method of FIG. 12 may be performed and/or controlled by one or more processors of the wireless device. Such wireless device may also include a memory storing program code for implementing at least some of the below described functionalities or steps of the method of FIG. 12.

At step 1210, the wireless device may receive configuration information. The wireless device may receive at least a part of the configuration information through broadcasted system information, e.g., in one or more SIBs. Alternatively or in addition, the wireless device may receive at least a part of the configuration information through RRC signaling. In some scenarios, the configuration information may configure the wireless device with multiple SMTCs.

At step 1220, the wireless device applies a first measurement configuration for at least one first measurement on one or more reference signals from one or more satellites of a satellite radio access network of the wireless communication network. The wireless device may perform the at least one first measurement in a first time window, e.g., defined by a first SMTC. The wireless device may perform the at least one first measurement based on a first set of receive beams.

At step 1230, the wireless device may determine a second measurement configuration based on the at least one first measurement performed at step 1220. Step 1230 may involve that, based on the at least one first measurement, the wireless device determines position information for at least one of the satellites. The wireless device may then determine the at least one second measurement configuration based on the determined position information, e.g., by adaptation of receive beam sweeping to the determined position information. The position information may include ephemeris data of the at least one satellite and/or a position of the wireless device relative to the at least one satellite, e.g., a GNSS position of the wireless device. In some scenarios, the wireless device may determine the second measurement configuration based on one or more rules indicated by the configuration information received at step 1210.

If the wireless device performs the at least one first measurement in a first time window and the at least one second measurement in a second time window, the wireless device may determine a degree of similarity of the first time window and the at least one second time window, e.g., as explained above for the SCD rule. The wireless device may then determine the at least one second measurement configuration based on the determined degree of similarity of the first time window and the at least one second time window. The first time window and the at least one second time window can be non-overlapping, partially overlapping, or fully overlapping. If the wireless device performs the at least one first measurement based on a first set of receive beams and the at least one second measurement is to be performed based on a second set of receive beams, the wireless device may determine a degree of similarity of at least one beam of the first set to at least one beam of the second set, e.g., as described above for the beam similarity rules. Step 1230 may then involve that the wireless device determines the at least one second measurement configuration based on the determined degree of similarity of the beams.

At step 1240, the wireless device applies a at least one second measurement configuration for at least one second measurement on the one or more reference signals from the one or more satellites of a satellite radio access network. The at least one second measurement configuration may correspond to the at least one second measurement configuration determined at step 1230. The second measurement configuration is based on the at least one first measurement performed at step 1220. The wireless device may perform the at least one second measurement in at least one second time window, e.g., defined by a second SMTC. In some scenarios, the wireless device may perform the at least one first measurement and the at least one second measurement within a single time window, e.g., defined by an SMTC. The wireless device may perform the at least one first measurement based on a first set of receive beams and perform the at least one second measurement based on a second set of receive beams.

If the one or more reference signals include at least one SSB, the first measurement configuration and the second measurement configuration may be based on at least one SMTC, e.g., a first SMTC and the second measurement configuration is based on a second SMTC, e.g., as explained for the measurement sequence of FIG. 7. In some scenarios, wherein the first measurement configuration and the second measurement configuration may be based on the same SMTC, e.g., as explained for the measurement sequence of FIG. 9.

At step 1250, the wireless device may send or receive data. This may be performed based on the measurements performed at steps 1220 and 1240, e.g., based on mobility procedures controlled based on the measurements. The data may be sent or received through a satellite-based node of the wireless communication network.

FIG. 13 shows a flowchart for illustrating a method, which may be utilized for implementing the illustrated concepts. The method of FIG. 13 may be used for implementing the illustrated concepts in a node of the wireless communication network, e.g., corresponding to one of the above-mentioned satellite-based nodes 100 or some other node of the wireless communication network, e.g., in the TN access node 101 or in the control node(s) 130.

If a processor-based implementation of the node is used, at least some of the steps of the method of FIG. 13 may be performed and/or controlled by one or more processors of the node. Such node may also include a memory storing program code for implementing at least some of the below described functionalities or steps of the method of FIG. 13.

In the method of FIG. 13, the node of the wireless communication network configures a wireless device, e.g., one of the above-mentioned UEs, to apply a first measurement configuration for at least one first measurement on one or more reference signals from one or more satellites of a satellite radio access network of the wireless communication network. Further, the node configures the wireless device to apply at least one second measurement configuration for at least one second measurement on the one or more reference signals from the one or more satellites of a satellite radio access network, with the second measurement configuration being based on the at least one first measurement.

At step 1310, the node may determine configuration information for configuring the wireless device to apply the first measurement configuration and the second measurement configuration. The configuration information may for example be determined in terms of system information to be broadcasted to the wireless device or in terms of one or more RRC IEs. In some scenarios, the configuration information may configure the wireless device with multiple SMTCs.

At step 1320, the node may send the configuration information to the wireless device. The node may send at least a part of the configuration information through broadcasted system information, e.g., in one or more SIBs. Alternatively or in addition, the wireless device may receive at least a part of the configuration information through RRC signaling.

In the method of FIG. 13, the node may configure the wireless device to perform the at least one first measurement in a first time window, e.g., defined by a first SMTC. The wireless device may perform the at least one first measurement based on a first set of receive beams.

Further, the node may configure the wireless device to determine the second measurement configuration based on the at least one first measurement. The node may configure the wireless device to determine position information for at least one of the satellites based on the at least one first measurement, and to determine the at least one second measurement configuration based on the determined position information, e.g., by adaptation of receive beam sweeping to the determined position information. The position information may include ephemeris data of the at least one satellite and/or a position of the wireless device relative to the at least one satellite, e.g., a GNSS position of the wireless device.

The node may configure the wireless device to perform the at least one first measurement in a first time window, e.g., defined by a first SMTC, and the at least one second measurement in a second time window, e.g., defined by a second SMTC. In such case, the node may configure the wireless device to determine a degree of similarity of the first time window and the at least one second time window, e.g., as explained above for the SCD rule. The node may then also configure the wireless device to determine the at least one second measurement configuration based on the determined degree of similarity of the first time window and the at least one second time window. The first time window and the at least one second time window can be non-overlapping, partially overlapping, or fully overlapping.

The node may configure the wireless device to perform the at least one first measurement based on a first set of receive beams and the at least one second measurement based on a second set of receive beams. The node may then also configure the wireless device to determine a degree of similarity of at least one beam of the first set to at least one beam of the second set, e.g., as described above for the beam similarity rules, and to determine the at least one second measurement configuration based on the determined degree of similarity of the beams.

The node may configure the wireless device to perform the at least one second measurement in at least one second time window, e.g., defined by a second SMTC. In some scenarios, the node may configure the wireless device may perform the at least one first measurement and the at least one second measurement within a single time window, e.g., defined by an SMTC. The node may then configure the wireless device to perform the at least one first measurement based on a first set of receive beams and perform the at least one second measurement based on a second set of receive beams.

If the one or more reference signals include at least one SSB, the first measurement configuration and the second measurement configuration may be based on at least one SMTC, e.g., a first SMTC and the second measurement configuration is based on a second SMTC, e.g., as explained for the measurement sequence of FIG. 7. In some scenarios, the first measurement configuration and the second measurement configuration may be based on the same SMTC, e.g., as explained for the measurement sequence of FIG. 9.

At step 1330, the node may send data to the wireless device or receive data from the wireless device. This may be performed based on the configured measurements, e.g., based on mobility procedures controlled based on the measurements. The data may be sent or received through a satellite-based node of the wireless communication network.

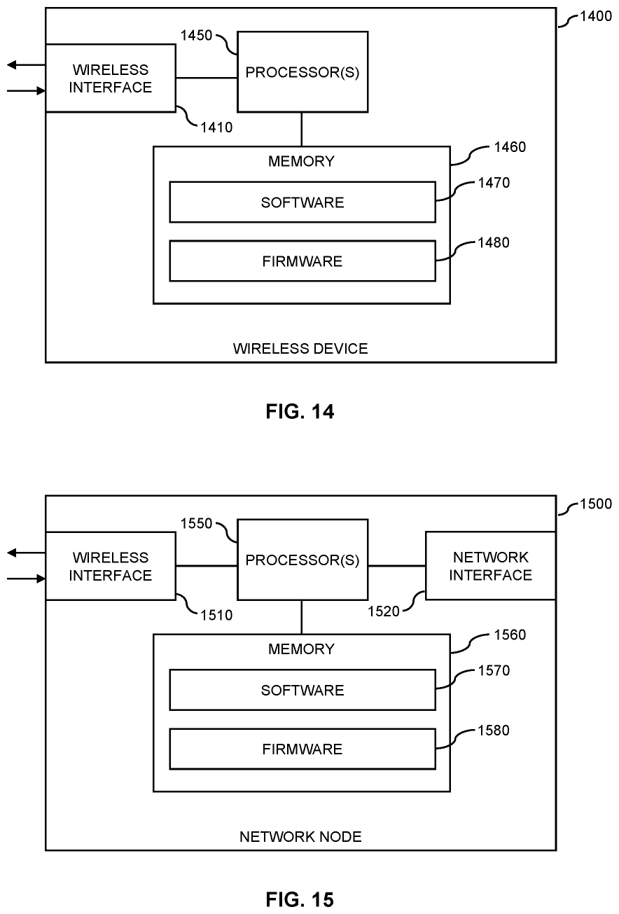

FIG. 14 schematically illustrates a processor-based implementation of a wireless device 1400 for operation in a wireless communication network, which may be used for implementing the above-described concepts. For example, the structures as illustrated in FIG. 14 may be used for implementing the concepts in one or more of the above-mentioned UEs 10.

As illustrated, the wireless device 1400 may include a wireless interface 1410. The wireless interface 1410 may be used for wireless communication with one or more nodes of the wireless communication network, such as the above-mentioned access nodes 100, 101.

Further, the wireless device 1400 may include one or more processors 1450 coupled to the wireless interface 1410 and a memory 1460 coupled to the processor(s) 1450. By way of example, the wireless interface 1410, the processor(s) 1450, and the memory 1460 could be coupled by one or more internal bus systems of the wireless device 1400. The memory 1460 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1460 may include software 1470 and/or firmware 1480. The memory 1460 may include suitably configured program code to be executed by the processor(s) 1450 so as to implement the above-described functionalities for controlling wireless communication, such as explained in connection with FIG. 12.

It is to be understood that the structures as illustrated in FIG. 14 are merely schematic and that the wireless device 1400 may actually include further components which, for the sake of clarity, have not been illustrated, e.g., further interfaces or further processors. Also, it is to be understood that the memory 1460 may include further program code for implementing known functionalities of a UE supporting the NR technology or the LTE technology. According to some embodiments, also a computer program may be provided for implementing functionalities of the wireless device 1400, e.g., in the form of a physical medium storing the program code and/or other data to be stored in the memory 1460 or by making the program code available for download or by streaming.

FIG. 15 schematically illustrates a processor-based implementation of a node 1500 for a wireless communication network, which may be used for implementing the above-described concepts. For example, the structures as illustrated in FIG. 15 may be used for implementing the concepts in one or more of the above-mentioned satellite-based nodes 100 or in some other node, in the TN access node 101 or in the control node(s) 130.

As illustrated, the node 1500 may include a wireless interface 1510 and a network interface 1520. The wireless interface 1510 may be used for wireless communication with one or more wireless device, such as the above-mentioned UEs 10. The network interface 1520 may be used for communication with one or more other nodes of the wireless communication network, e.g., access nodes or CN nodes.

Further, the node 1500 may include one or more processors 1550 coupled to the interfaces 1510, 1520 and a memory 1560 coupled to the processor(s) 1550. By way of example, the interfaces 1510, 1520, the processor(s) 1550, and the memory 1560 could be coupled by one or more internal bus systems of the node 1500. The memory 1560 may include a ROM, e.g., a flash ROM, a RAM, e.g., a DRAM or SRAM, a mass storage, e.g., a hard disk or solid state disk, or the like. As illustrated, the memory 1560 may include software 1570 and/or firmware 1580. The memory 1560 may include suitably configured program code to be executed by the processor(s) 1550 so as to implement the above-described functionalities for controlling wireless communication, such as explained in connection with FIG. 13.

It is to be understood that the structures as illustrated in FIG. 15 are merely schematic and that the node 1500 may actually include further components which, for the sake of clarity, have not been illustrated, e.g., further interfaces or further processors. Also, it is to be understood that the memory 1560 may include further program code for implementing known functionalities of a gNB of the NR technology, an eNB of the LTE technology, or similar type of access node. According to some embodiments, also a computer program may be provided for implementing functionalities of the node 1500, e.g., in the form of a physical medium storing the program code and/or other data to be stored in the memory 1560 or by making the program code available for download or by streaming.

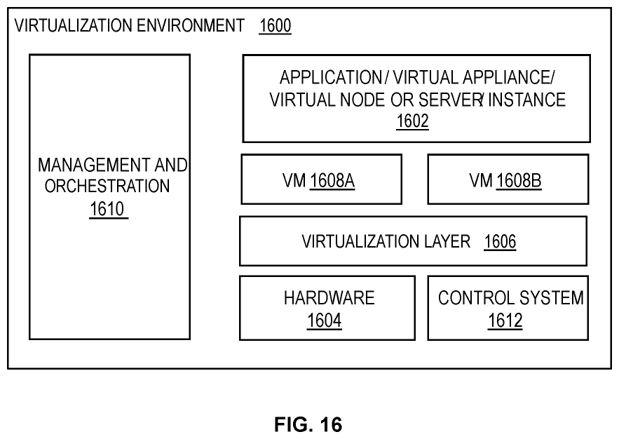

FIG. 16 is a block diagram illustrating a virtualization environment 1600 in which functions implemented by some embodiments may be virtualized, such as the above-described functionalities of a satellite-based node. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608B and 1608B (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Such radio units may also include satellite based radio units. Radio units may communicate directly with other hardware nodes via one or more appropriate network interfaces and may be used in combination with the virtual components to provide a virtual node with radio capabilities, such as a satellite based radio access node, a terrestrial radio access node or a base station. In some embodiments, some signaling can be provided with the use of a control system 1612 which may alternatively be used for communication between hardware nodes and radio units.

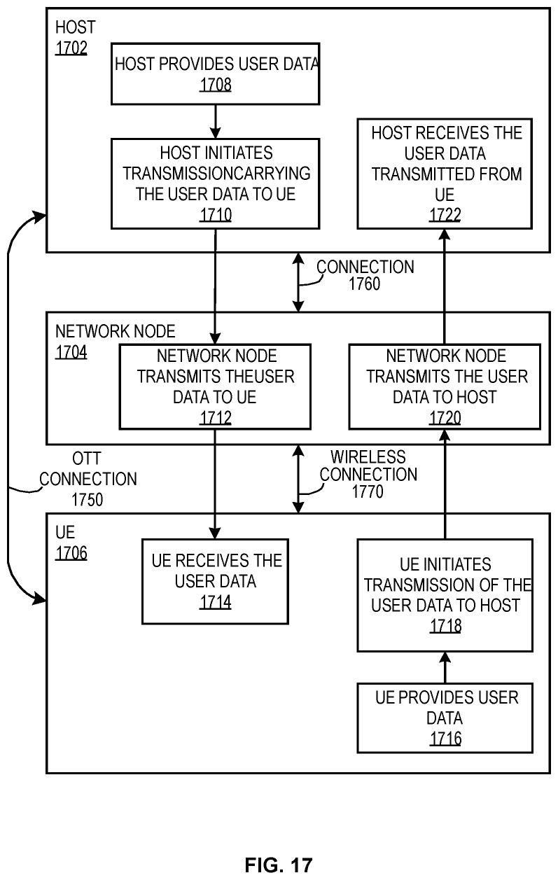

FIG. 17 shows a communication diagram of a host 1702 communicating via a network node 1704 with a UE 1706 over a partially wireless connection in accordance with some embodiments. Example implementations, in accordance with various embodiments, of the UE (such as one of the above-mentioned UEs 10), network node (such as one of the above-mentioned base stations), and host (such as the above-mentioned service platform 150 or application server(s) 180) will now be described with reference to FIG. 17.

Embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 110 of FIG. 4) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1716, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

The illustrated concepts may help to improve, performance of OTT services provided to the UE 1706 using the OTT connection 1750, in which the wireless connection 1770 forms the last segment. More precisely, the teachings of these embodiments may improve the efficiency of measurements for managing the wireless connection 1770 and thereby allow for more precisely and efficiently perform transfers on the last segment of the OTT connection 1750. This provides an improvement to an OTT service such as ensuring the optimum user plane and control plane connections running over wireless links are maintained providing faster transmission rates and reduced latency.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc. ; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

As can be seen, the concepts as described above may be used for efficiently managing measurements of reference signals from satellites. Specifically, measurement configurations may be determined in an adaptive manner, so that measurement durations can be reduced. This can provide significant benefits in certain frequency ranges where RX beam sweeping is needed, such as the FR2 range. As a result, cell changes and other mobility procedures of a UE can be facilitated.

It is to be understood that the examples and embodiments as explained above are merely illustrative and susceptible to various modifications. For example, the illustrated concepts may be applied in connection with various kinds of communication technologies, without limitation to wireless technologies or a technology specified by 3GPP. Further, the illustrated concepts may be applied for measurements on various kinds of reference signals, without limitation to SSBs. Moreover, it is to be understood that the above concepts may be implemented by using correspondingly designed software to be executed by one or more processors of an existing device or apparatus, or by using dedicated device hardware. Further, it should be noted that the illustrated nodes, apparatuses or devices may each be implemented as a single device or as a system of multiple interacting devices or modules, e.g., based on virtualized cloud components.

1-44. (canceled)

45. A method of controlling wireless communication in a wireless communication network, the method of comprising:
a wireless device applying a first measurement configuration for at least one first measurement on one or more reference signals from one or more satellites of a satellite radio access network of the wireless communication network;
based on the at least one first measurement, the wireless device determining position information for at least one of the satellites, the wireless device determining at least one second measurement configuration based on the determined position information, wherein determining the second measurement configuration comprises adaptation of receive beam sweeping to the determined position information; and
the wireless device applying the at least one second measurement configuration for at least one second measurement on the one or more reference signals from the one or more satellites of a satellite radio access network, wherein
the second measurement configuration is based on the at least one first measurement.

46. The method of claim 45, wherein the position information comprises a position of the wireless device relative to the at least one satellite.

47. The method of claim 45, wherein the method further comprises
the wireless device performing the at least one first measurement in a first time window; and
the wireless device performing the at least one second measurement in at least one second time window.

48. The method of claim 47, wherein the method further comprises
the wireless device determining a degree of similarity of the first time window and the at least one second time window; and
the wireless device determining the at least one second measurement configuration based on the determined degree of similarity of the first time window and the at least one second time window.

49. The method of claim 47, wherein the first time window and the at least one second time window are one of:
non-overlapping;
partially overlapping; or
fully overlapping.

50. The method of claim 45, wherein the method further comprises
the wireless device performing the at least one first measurement based on a first set of receive beams; and
the wireless device performing the at least one second measurement based on a second set of receive beams.

51. The method of claim 50, wherein the method further comprises
the wireless device determining a degree of similarity of at least one beam of the first set to at least one beam of the second set; and
the wireless device determining the at least one second measurement configuration based on the determined degree of similarity of the beams.

52. The method of claim 45, wherein
the one or more reference signals comprise at least one Synchronization Signal Block (SSB),
the first measurement configuration and the second measurement configuration are based on at least one SSB Measurement Timing configuration (SMTC),
the first measurement configuration is based on a first SMTC,
the second measurement configuration is based on a second SMTC, and
the first measurement configuration and the second measurement configuration are based on the same SMTC.

53. The method of claim 45, wherein the method further comprises
the wireless device receiving configuration information from a node of the wireless communication network; and
the wireless device determining the second measurement configuration based on one or more rules indicated by the configuration information.

54. A method of controlling wireless communication in a wireless communication network, the method of comprising:
a node of the wireless communication network configuring a wireless device to apply a first measurement configuration for at least one first measurement on one or more reference signals from one or more satellites of a satellite radio access network of the wireless communication network;
the node configuring the wireless device to determine position information for at least one of the satellites based on the at least one first measurement;
the node configuring the wireless device to determine the at least one second measurement configuration based on the determined position information, wherein determining the second measurement configuration comprises adaptation of receive beam sweeping to the determined position information; and
the node configuring the wireless device to apply at least one second measurement configuration for at least one second measurement on the one or more reference signals from the one or more satellites of a satellite radio access network, wherein
the second measurement configuration is based on the at least one first measurement.

55. The method of claim 54, wherein the position information comprises a position of the wireless device relative to the at least one satellite.

56. The method of claim 54, comprising:
the node configuring the wireless device to perform the at least one first measurement in a first time window to perform the at least one second measurement in at least one second time window.

57. The method of claim 56, comprising:
the node configuring the wireless device to determine the at least one second measurement configuration based on the determined degree of similarity of the first time window and the at least one second time window

58. The method of claim 56, wherein the first time window and the at least one second time window are one of:
non-overlapping;
partially overlapping; and
fully overlapping.

59. The method of claim 54, comprising:
the node configuring the wireless device to perform the at least one first measurement based on a first set of receive beams and to perform the at least one second measurement based on a second set of receive beams.

60. The method of claim 59, comprising:
the node configuring the wireless device to determine the at least one second measurement configuration based on a degree of similarity of at least one beam of the first set to at least one beam of the second set.

61. The method of claim 54, wherein
the one or more reference signals comprise at least one Synchronization Signal Block (SSB),
the first measurement configuration and the second measurement configuration are based on at least one SSB Measurement Timing configuration (SMTC),
the first measurement configuration is based on a first SMTC,
the second measurement configuration is based on a second SMTC, and
the first measurement configuration and the second measurement configuration are based on the same SMTC.

62. The method of claim 54, comprising:
the node sending configuration information to the wireless device, the configuration information indicating one or more rules to be applied by the wireless device for determining the second measurement configuration.

63. A wireless device for operation in a wireless communication network, the wireless device being adapted to:
apply a first measurement configuration for at least one first measurement on one or more reference signals from one or more satellites of a satellite radio access network of the wireless communication network;
based on the at least one first measurement, the wireless device determine position information for at least one of the satellites, the wireless device determining the at least one second measurement configuration based on the determined position information, wherein determining the second measurement configuration comprises adaptation of receive beam sweeping to the determined position information; and
apply at least one second measurement configuration for at least one second measurement on the one or more reference signals from the one or more satellites of a satellite radio access network, wherein
the second measurement configuration is based on the at least one first measurement.

64. A node for a wireless communication network, the node being adapted to:
configure a wireless device to apply a first measurement configuration for at least one first measurement on one or more reference signals from one or more satellites of a satellite radio access network of the wireless communication network;
configure the wireless device to determine position information for at least one of the satellites based on the at least one first measurement;
configure the wireless device to determine the at least one second measurement configuration based on the determined position information, wherein determining the second measurement configuration comprises adaptation of receive beam sweeping to the determined position information; and
configure the wireless device to apply at least one second measurement configuration for at least one second measurement on the one or more reference signals from the one or more satellites of a satellite radio access network, wherein
the second measurement configuration is based on the at least one first measurement.
